(19) United States
(12) Patent Application Publication
(10) Pub. No.: US 2021/0016598 A1
(43) Pub. Date: Jan. 21, 2021

(54) MULTI-LAYERED DECORATIVE WRAP AND METHOD OF USE OF THE SAME

(71) Applicant: Eliot I. RUBIN, Boca Raton, FL (US)

(72) Inventor: Eliot I. RUBIN, Boca Raton, FL (US)

(21) Appl. No.: 16/766,922

(22) PCT Filed: Nov. 20, 2018
(86) PCT No.: PCT/US2018/061933

§ 371 Date: May 26, 2020

Related U.S. Application Data
(60) Provisional application No. 62/707,988, filed on Nov. 28, 2017.

(51) Int. Cl. B44C 1/10; B32B 7/12; C09J 7/29

(52) U.S. Cl. CPC B44C 1/105; B32B 7/12; B32B 2605/00; B32B 2405/00; B32B 2451/00; C09J 7/29

(57) ABSTRACT

A decorative wrap of the type used for covering automotive and other surfaces for decorative or protective purposes. The wrap is multi-layered such that multiple film layers are applied in a single application, but can be individually removed. Tabs or staggered layers can be added to facilitate the initiation of removal of a given film layer.

### CROSS-REFERENCE TO RELATED APPLICATIONS

This PCT application claims the benefit under 35 U.S.C. § 119(e) of U.S. Patent Application Ser. No. 62/707,988, filed on Nov. 28, 2017, entitled MULTI-LAYERED REMOVABLE WRAP. The entire disclosure of this provisional application is incorporated by reference herein.

### FIELD OF THE INVENTION

This invention relates generally to wraps for decorating object, and more particularly to a decorative wrap formed of plural flexible film layers, such that the decorative wrap can be applied to an exterior surface of an object, such as an automobile, wherein the decoration can be readily changed by removing one of the layers of the wrap.

### BACKGROUND OF THE INVENTION

Decorative wraps are well known for use in a large number of applications. Such wraps are typically made of a thin vinyl or acrylic material with a self-adhesive. For example, it is well-known to use a wrap to enhance the appearance of an automobile. Such wraps are used to modify the color and/or texture of an automobile and the pattern of color on an automobile, as well as to provide decorative looks, graphics, and advertising. Wraps useful in automotive applications are available from the 3M Company, marketed such as 3M Wrap Film Series 1080, and from Avery Dennison Corporation marketed as vehicle wrapping films such as Supreme Wrapping Film SW 900 and digitally printable films particularly suited to receive print. Automotive partial wraps can be used to apply an appearance of such decorations as racing stripes and other color accents. Wraps can be used in lieu of repainting of the surface of an automobile or other item.

Wraps of varying materials can also be used to change the appearance and/or the texture of many things such as walls and windows, furniture, appliances, commercial windows, and other uses.

Wraps are typically made as a decorative film removably adhered by an adhesive to a protective paper backing. A laborer typically cleans and prepares the surface to be covered, removes the paper backing from the decorative film, and applies the wrap to the surface to be covered. The adhesive joining the decorative film to the paper backing is typically the adhesive that bonds the decorative film to the surface.

In this manner, a single wrap is applied to the desired surface. In some cases, for aesthetic appearance, the decorative film can be made as two layers intimately and permanently bonded together. This is done, for example, as a permanently bonded overlaminate of a generally transparent film to customize the look of an underlying wrap film. It is often done by using a generally transparent but colored outer layer laminated over an inner layer to give a different look or hue to the underlying color.

Thus, if one wants to change the exterior color of an automobile from, for example, white to red, labor is required to apply the red wrap over the white paint. If a year later, it is desired to change the color from red to blue; another application of another wrap is required. Typically the old red wrap is removed and the new blue wrap is applied to the original white painted surface. Alternatively, the new blue wrap can be applied over the old red wrap. In any event, the outer surface which will be covered by the new blue wrap must be cleaned and prepared to accept the new wrap. To make these color changes twice requires a significant amount of labor, basically performed twice. A third color change requires a third application of this labor, and so forth. Often, when such wrap changes are made, the overall quality of the appearance of the new layer is lessened, particularly if the prior wrap and adhesive are not carefully removed and the surface well prepared.

Wraps are often attached to an underlying part surface by wrapping the exterior of the wrap film around the edge of the surface. In this manner, the part, such as the upper surface and edge of an automotive hood, is completely covered in an aesthetically pleasing manner. To remove the wrap, a laborer, typically using a tool, or often a fingernail, lifts an edge of the wrap which has been bonded to the back or bottom surface of the hood, grabs that lifted section, and pulls to remove the wrap from the back and from the entire top surface of the hood. Heat is often used to assist in lifting the starting edge.

As should be appreciated by those skilled in the art, vinyl wraps either with printed media or other decorated films are commonly configured to allow them to be changed at the will of the user. However, current vinyl wraps and methods of using them typically require significant labor for the installer and costs to the consumer when a vinyl wrap is changed. The process of changing a vinyl wrap leave much, e.g., requiring a very time consuming process of removing the existing vinyl wrap prior to installing a new one. This greatly limits to full potential of vinyl wrap applications. Therefore, there is a need to provide a wrap whose usage will reduce labor involved in applying it to the object to be decorated, removing it from the object to be decorated, enabling making multiple changes to the wrap, and making changes more accessible to consumers and more affordable, while providing a more profitable business model for installers. The subject invention addresses those needs by providing a multi-layered wrap which can be readily applied to the object to be decorated, and wherein one outer layer can readily and simply be removed from an inner layer which is secured to the object.

### SUMMARY OF THE INVENTION

One aspect of this invention is a decorative wrap for decorating an object, e.g., a vehicle, the decorative wrap comprises at least two layers of a flexible film, the at least two layers comprising a first layer and a second layer. The second layer is disposed over the first layer and has an upper surface and an undersurface. The first layer has an upper surface and an undersurface. At least one of the layers is decorated with a decoration, e.g., a color and/or a graphic. A first releasably securable adhesive is provided on the undersurface of the first layer for releasable securement to an exterior surface of the object. A second releasably securable adhesive is interposed between the upper surface of the first layer and the undersurface of the second layer, whereupon when the first releasably securable adhesive is secured to the surface of the object the upper surface of the second layer is visible so that the decoration can be seen. The second layer is configured to be removed from the first layer leaving the first layer in place on the object.

In accordance with one preferred aspect of the decorative wrap of this invention both of the layers are decorated with a respective decoration.

In accordance with another preferred aspect of the decorative wrap of this invention the decoration comprises at least one of a color and a graphic.

In accordance with another preferred aspect of the decorative wrap of this invention the decorative wrap additionally comprises a liner layer releasably secured to the first releasably securable adhesive on said undersurface of the first layer. The liner layer is configured for removal from the first releasably securable adhesive to expose the first releasably securable adhesive.

In accordance with another preferred aspect of the decorative wrap of this invention the second layer comprises at least one tab configured for enabling a user to grasp the at least one tab to remove the second layer from the first layer.

In accordance with another preferred aspect of the decorative wrap of this invention the first layer includes a peripheral edge portion, and wherein the second layer includes a peripheral edge portion, with the at least one tab extending from the peripheral edge portion of the second layer and beyond the peripheral edge portion of the first layer.

In accordance with another preferred aspect of the decorative wrap of this invention the second layer includes at least one peripheral edge portion and the first layer includes at least one peripheral edge portion, and wherein the at least one peripheral edge portion of the second layer extends beyond the at least one peripheral edge portions of said the layer.

In accordance with another preferred aspect of the decorative wrap of this invention the decorative wrap additionally comprises a third layer of a flexible film which is releasably secured to the upper surface of the second layer by a releasably securable adhesive.

In accordance with another preferred aspect of the decorative wrap of this invention the at least one of the first, second and third layer comprises a decoration.

Another aspect of this invention is a decorated vehicle comprising a vehicle having an exterior surface and a decorative wrap decorating the exterior surface of the vehicle. The decorative wrap comprises at least two layers of a flexible film, the at least two layers comprising a first layer and a second layer. The second layer is disposed over the first layer and has an upper surface and an undersurface. The first layer has an upper surface and an undersurface. At least one of the layers is decorated with a decoration, e.g., a color and/or a graphic. A first releasably securable adhesive is provided on the undersurface of the first layer for releasable securement to an exterior surface of the vehicle. A second releasably securable adhesive is interposed between the upper surface of the first layer and the undersurface of the second layer, whereupon when the first releasably securable adhesive is secured to the exterior surface of the vehicle the upper surface of the second layer is visible so that the decoration can be seen. The second layer is configured to be removed from the first layer leaving the first layer in place on the object.

In accordance with one preferred aspect of the decorated vehicle of this invention the decoration comprises at least one of a color and a graphic.

In accordance with another preferred aspect of the decorated vehicle of this invention the decorative wrap additionally comprises a third layer of a flexible film which is releasably secured to the upper surface of the second layer by a releasably securable adhesive.

In accordance with another preferred aspect of the decorated vehicle of this invention the at least one of the first, second and third layer comprises a decoration.

In accordance with another preferred aspect of the decorated vehicle of this invention the decoration comprises at least one of a color and a graphic.

Another aspect of this invention is a method of decorating a vehicle, having an exterior surface. The method comprises providing a decorative wrap comprising at least two layers of a flexible film, the at least two layers comprises a first layer, and a second layer. The first layer has an upper surface and an undersurface. The second layer has an upper surface and an undersurface. At least one of the layers is decorated with a decoration, e.g., at least one of a color and a graphic. The first and second layers are releasably secured together by a releasably securable adhesive whereupon the second layer is disposed over the first layer. The undersurface of the first layer includes another releasably securable adhesive. The decorative wrap is applied to the exterior surface whereupon the other releasably securable adhesive releasably secures the decorative wrap on the exterior surface such that the decoration is visible. The second layer is configured to be removed from the first layer when desired, leaving the first layer in place on the exterior surface.

In accordance with one preferred aspect of the method of this invention the second layer comprises at least one tab configured for enabling a user to grasp the at least one tab to remove the second layer from the first layer when desired.

In accordance with another preferred aspect of the method of this invention the first layer includes a peripheral edge portion, and wherein the second layer includes a peripheral edge portion. The at least one tab extends from the peripheral edge portion of the second layer and beyond the peripheral edge portion of the first layer.

In accordance with another preferred aspect of the method of this invention the second layer includes at least one peripheral edge portion and the first layer includes at least one peripheral edge the at least one peripheral edge portion of said first layer.

In accordance with another preferred aspect of the method of this invention the method comprises removing the second layer from the first layer by peeling or separating a portion of said second layer from an underlying portion of said first layer to produce an open interface therebetween and introducing an adhesive remover into said open interface.

### BRIEF DESCRIPTION OF THE DRAWING FIGURES

FIG. 1 is a greatly enlarged cross sectional view of a multi-layered decorative wrap constructed in accordance with this invention and comprising a plurality of readily removable film layers;

FIG. 2A is a reduced plan view of a portion of a wrap constructed in accordance with this invention and showing a pair of tabs integrally formed with one of film layer of the wrap for facilitating the removal of that layer from the wrap;

FIG. 2B is a reduced plan view of an alternative configuration of a wrap like shown in FIG. 2A, but with the pair of tabs being releasably secured to the film layer;

FIG. 2C is a plan view of one of the tabs shown in FIG. 2B;

FIG. 3 is a greatly enlarged cross-sectional view of an edge of a surface of an object to be decorated, e.g., the hood of a vehicle, shown decorated with a single layer decorative wrap having tabs like that of FIG. 2A or 2B;

FIG. 4 is a greatly enlarged cross-sectional view of an edge of a surface of an object to be decorated, e.g., the hood of a vehicle, shown decorated with a multiple layer decorative wrap having tabs like that of FIG. 2A or 2B;

FIG. 5 is a greatly enlarged cross-sectional view of a multi-layered wrap having offset extremities constructed in accordance with another aspect of this invention; and

FIG. 6 is a reduced plan view of a multi-layered wrap having readily removable film layers manufactured in two colors with a preset margin or border.

### DETAILED DESCRIPTION OF THE PREFERRED EMBODIMENTS

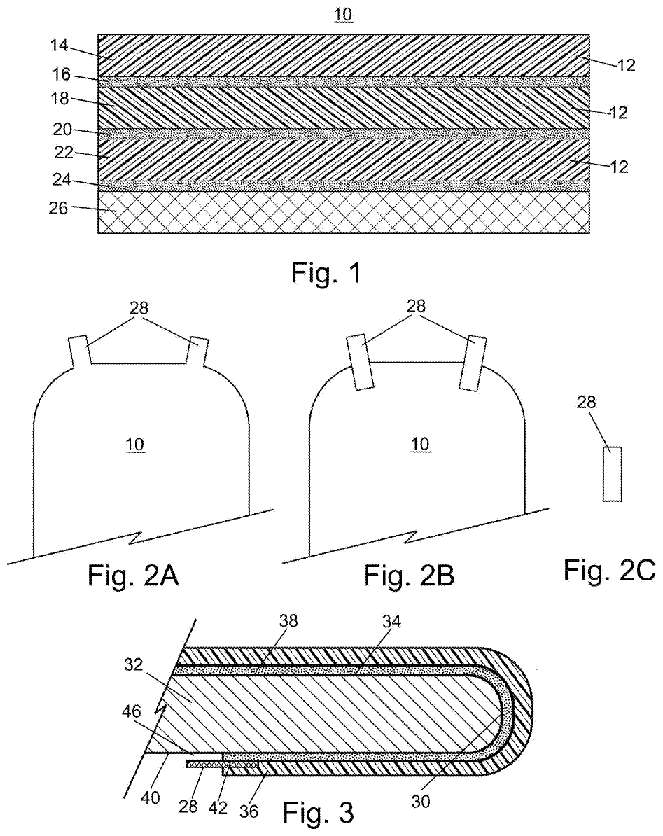

Referring now to FIG. 1, there is shown a cross-section of a multi-layered decorative wrap 10 constructed in accordance with one embodiment of this invention. The decorative wrap 10 includes a plurality, in this case three, peelable or easily removable film layers 12. The wrap 10 includes an outermost film layer 14, an adhesive layer 16, an intermediate film layer 18, another adhesive layer 20, an inner film layer 22, a backing adhesive 24, and a backing or removable liner 26. FIG. 1 thus shows three selectively independently peelable layers 12. While the embodiment 10 shows three film layers 12, the subject invention contemplates at least two such layers. In fact, there can be any number of layers, providing that they are independently removable.

The film layers 12 can be made of vinyl, acrylic, or other materials providing an appearance modification or a protective function to an underlying surface. At least one of the plural film layers is decorated. The decoration can take various forms, e.g., color, graphics and combinations thereof. Moreover, the color and/or graphics may encompass the entire film layer or only a portion of the film layer. For applications wherein the decorative wrap includes two film layers, each of those film layers can be decorated, and the decoration of each layer may be different or the same. Moreover, it is contemplated that for some applications the uppermost of the layers may not itself be decorated, but may be transparent or translucent to enable the decoration of an underlying layer to be seen therethrough.

The adhesive between film layers is preferably releasably securable, that is strong enough to join the film layers and hold them together during application and use, yet frail or weak enough to allow one layer to be readily removed, e.g., peeled, from the adjacent layer when desired. In this manner, the film layers can be independently removed from one another. Differing strength adhesives can be used between different layers, or laterally within the same adhesive layer. Preferably, after removal of an outer layer, the underlying exposed layer is of good appearance and can be made of high-quality appearance with merely a reasonable amount of cleaning, buffing, washing or similar preparation. During manufacture of the multi-layered wrap 10, the adhesive layer between films may be two layers itself, one being a release material. The backing adhesive 24 can be consistent with backing adhesives currently in use.

The backing or liner layer 26 is constructed similarly to conventional liner sheets used to cover an adhesive until the adhesive is to be exposed for use. Such backing or liner layers are typically made of a paper type material. The backing or liner layer 26 is removed from the backing adhesive 24 to expose the backing adhesive prior to applying the wrap 10 to an underlying surface of an object to be decorated, e.g., a vehicle.

FIGS. 2A and 2B show the decorative wrap 10 as including tabs 28 projecting outward from a peripheral edge of the wrap. The tabs 28 are useful for assisting in the peeling of a wrap or a wrap layer from an underlying surface. Removal of a wrap from a surface typically involves lifting up an extremity of the wrap and then pulling off the wrapping material from the surface to which it is attached. It can be difficult to start this process, and a tool or fingernail, and sometimes heat, is often used. In accordance with the invention, a tab 28 is simply grabbed and lifted to starts the removal process. The tabs 28 can be made integrally formed with a wrap film layer (as shown in FIG. 2A), or can be separate components, like shown in FIG. 2C, but adhered, e.g., permanently adhesively secure, to the relevant film layer of the wrap (as shown in FIG. 2B). The tabs 28 can be manufactured separately and attached by the laborer working with the wrap.

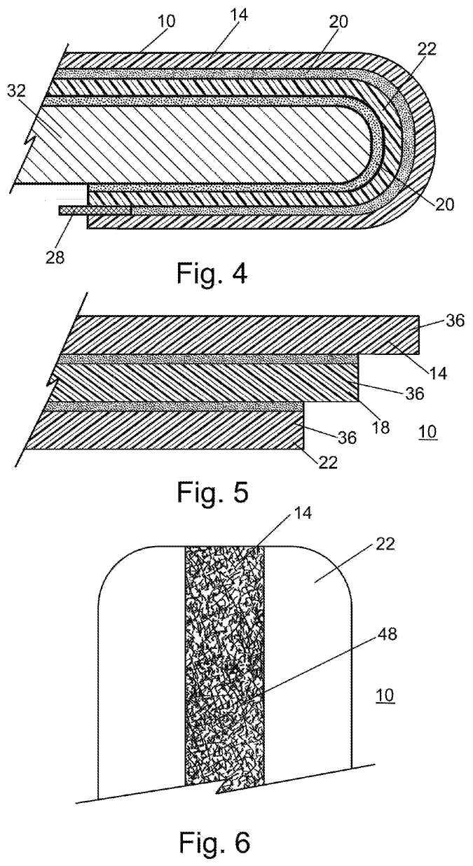

If the decorative wrap only includes one film layer, one or more tab 28 can be used with that layer to remove it from the object which has been decorated by that wrap. In particular, FIG. 3 shows the edge 30 of a wrapped surface 32, such as an automobile hood, with a single layer wrap 10 bonded across the top 34 of surface 32 and folded around and under the edge 30. The extremity 36 of the wrap 10 is bonded by adhesive 38 to the bottom 40 of surface 32, and tab 28 is bonded to the wrap 10. A portion 42 of tab 28 can be bonded to the surface 32, and a second portion 44 can be spaced 46 from the bottom 40 of surface 32. The tab 28 can be easily lifted at the spaced 46 area to start the process of removal of the wrap.

Whereas FIG. 3 shows a wrap with a single film layer, FIG. 4 shows a wrap 10 with multiple, e.g., two, film layers and two adhesive layers. A tab 28 is positioned between consecutive independently peelable film layers. Thus, FIG. 4 shows an outermost film layer 14, an adhesive layer 20, an inner film layer 22, another adhesive layer 20, and a tab 28, with the wrap folded around surface 32. The tab 28 extends beyond the peripheral edge of the inner layer 22 so that it can be grasped and pulled to start the process of removing the outermost layer 14 from the inner film layer 22.

FIG. 5 shows another embodiment of a wrap 10 constructed in accordance with this invention. In that embodiment there are three staggered film layers 14, 18 and 22, with a peripheral edge of the uppermost layer 14, extending beyond the underlying peripheral edge of the middle layer 18, and with the peripheral edge of the middle layer 18 extending beyond the underlying peripheral edge of the lower layer 22. While not shown in FIG. 5, the undersurface of the layer 22 includes the adhesive layer 24 to secure the wrap of FIG. 5 onto the exterior surface of the object to be decorated. As should be appreciated by those skilled in the art, the configuration of FIG. 5 facilitates the start of removal of one film layer from an underlying film layer of the multi-layered wrap since it enables one to grasp an overhanging peripheral edge portion (the extremity) of any of the layers to lift that layer independently and begin a removal process.

FIG. 6 shows a plan view of another embodiment of a multi-layered readily independently removable decorative wrap 10 constructed in accordance with this invention, wherein the innermost layer 22 is of a different width than outermost layer 14. This allows, for example, the appearance of a racing stripe 48 on a car hood. The outermost layer 14 can be removed leaving a single color on the underlying surface. Multiple layers each of different width can be utilized.

It should be pointed out at this juncture that in some cases, depending upon the strength of the particular material making up the film layers and the strength particular releasably securable adhesive that is used therebetween, removal of the top film layer from the underlying layer may not be as easy as desired. In such a case, it is contemplated that a user can make use of a liquid spray adhesive remover to facilitate removal of one film layer from an underlying film layer. In particular, that can be accomplished by starting to peel the top film layer from the underlying film layer and spraying the interface that is created between those layers by the peeling action so that the adhesive remover enters that interface to dissolve the adhesive between those layers, thereby rendering the peeling action extremely easy and neat.

As should be appreciated by those skilled in the art from the discussion above, the decorative wraps of the subject invention enable one to readily and easily decorate an object, e.g., a vehicle, and to change the decorative appearance of an underlying surface through independently removing an outer film layer from an underlying film adhered to the underlying surface. This can allow for changes in appearance as well as changes in the protective nature of a covering wrap. Moreover, a key benefit of the invention is that multiple independently removable layers can be applied in a single application, significantly reducing the labor involved in changing wraps.

Without further elaboration the foregoing will so fully illustrate our invention that others may, by applying current or future knowledge, adopt the same for use under various conditions of service.

1. A decorative wrap for decorating an object, said decorative wrap comprising:
at least two layers of a flexible film, said at least two layers comprising a first layer and a second layer, said second layer being disposed over said first layer, said first layer having an upper surface and an undersurface, said second layer having an upper surface and an undersurface, at least one of said layers being decorated with a decoration;
a first releasably securable adhesive on said undersurface of said first layer for releasable securement to an exterior surface of said object; and
a second releasably securable adhesive interposed between said upper surface of said first layer and said undersurface of said second layer, whereupon when said first releasably securable adhesive is secured to said exterior surface of said object said upper surface of said second layer is visible so that said decoration can be seen, said second layer being configured to be removed from said first layer leaving said first layer in place on the object.

2. The decorative wrap of claim 1, wherein both of said layers are decorated with a respective decoration.

3. The decorative wrap of claim 1, wherein said decoration comprises at least one of a color and a graphic.

4. The decorative wrap of claim 1, additionally comprising a liner layer releasably secured to said first releasably securable adhesive on said undersurface of said first layer, said liner layer being configured for removal from said first releasably securable adhesive to expose said first releasably securable adhesive.

5. The decorative wrap of claim 1, wherein said second layer comprises at least one tab configured for enabling a user to grasp said at least one tab to remove said second layer from said first layer.

6. The decorative wrap of claim 5, wherein said first layer includes a peripheral edge portion, and wherein said second layer includes a peripheral edge portion, said at least one tab extending from said peripheral edge portion of said second layer and beyond said peripheral edge portion of said first layer.

7. The decorative wrap of claim 1, wherein said second layer includes at least one peripheral edge portion and said first layer includes at least one peripheral edge portion, and wherein said at least one peripheral edge portion of said second layer extends beyond said at least one peripheral edge portions of said first layer.

8. The decorative wrap of claim 1, additionally comprising a third layer of a flexible film which is releasably secured to said upper surface of said second layer by a releasably securable adhesive.

9. The decorative wrap of claim 7, wherein said at least one of said first, second and third layer comprises a decoration.

10. The decorative wrap of claim 8, wherein said decoration comprises at least one of a color and a graphic.

11. A decorated vehicle comprising:
a vehicle having an exterior surface; and
a decorative wrap decorating said exterior surface of said vehicle, said decorative wrap comprising:
at least two layers of a flexible film, said at least two layers comprising a first layer and a second layer, said second layer being disposed over said first layer, said first layer having an upper surface and an undersurface, said second layer having an upper surface and an undersurface, at least one of said layers being decorated with a decoration;
a first releasably securable adhesive on said undersurface of said first layer for releasable securement to said exterior surface of said r vehicle; and
a second releasably securable adhesive interposed between said upper surface of said first layer and said undersurface of said second layer, whereupon when said first releasably securable adhesive is secured to said exterior surface of said vehicle said upper surface of said second layer is visible so that said decoration can be seen, said second layer being configured to be removed from said first layer leaving said first layer in place on said vehicle.

12. The decorated vehicle of claim 11, wherein said decoration comprises at least one of a color and a graphic.

13. The decorated vehicle of claim 11, additionally comprising a third layer of a flexible film which is releasably secured to said upper surface of said second layer by a releasably securable adhesive.

14. The decorated vehicle of claim 13, wherein said at least one of said first, second and third layer comprises a decoration.

15. The decorated vehicle of claim 14, wherein said decoration comprises at least one of a color and a graphic.

16. A method of decorating a vehicle having an exterior surface, said method comprising:
providing a decorative wrap comprising at least two layers of a flexible film, said at least two layers comprising a first layer, and a second layer, said first layer having an upper surface and an undersurface, said second layer having an upper surface and an undersurface, at least one of said layers being decorated with a decoration, said first and second layers being releasably secured together by a releasably securable adhesive whereupon said second layer is disposed over said first layer, said undersurface of said first layer including another releasably securable adhesive; and
applying said decorative wrap to said exterior surface whereupon said another releasably securable adhesive releasably secures said decorative wrap on said exterior surface such that said decoration is visible, said second layer being configured to be removed from said first layer when desired, leaving said first layer in place on said exterior surface of said vehicle.

17. The method of claim 16, wherein said second layer comprises at least one tab configured for enabling a user to grasp said at least one tab to remove said second layer from said first layer when desired.

18. The method of claim 17, wherein said first layer includes a peripheral edge portion, and wherein said second layer includes a peripheral edge portion, said at least one tab extending from said peripheral edge portion of said second layer and beyond said peripheral edge portion of said first layer.

19. The method of claim 16, wherein said second layer includes at least one peripheral edge portion and said first layer includes at least one peripheral edge portion, and wherein said at least one peripheral edge portion of said second layer extends beyond said at least one peripheral edge portion of said first layer.

20. The method of claim 16, wherein said method comprises removing said second layer from said first layer by peeling or separating a portion of said second layer from an underlying portion of said first layer to produce an open interface therebetween and introducing an adhesive remover into said open interface

21. The decorative wrap of claim 1, wherein the object comprises the body of a vehicle having an exterior surface which is curved, and wherein said second layer is transparent to enable the appearance of said first layer to be seen through said second layer.

22. The decorated vehicle of claim 11, wherein the vehicle comprises a body having an exterior surface which is curved, and wherein said second layer is transparent to enable the appearance of said first layer to be seen through said second layer.

23. The method of claim 16, wherein the vehicle comprises a body having an exterior surface which is curved, and wherein said second layer is transparent to enable the appearance of said first layer to be seen through said second layer.
